(19) United States
(12) Patent Application Publication
(10) Pub. No.: US 2016/0133176 A1
(43) Pub. Date: May 12, 2016

(54) METHOD OF OPERATING DISPLAY PANEL AND DISPLAY APPARATUS PERFORMING THE SAME

(71) Applicant: SAMSUNG DISPLAY CO., LTD., Yongin-City (KR)

(72) Inventors: Won-Sik Oh, Seoul (KR); Cheol-Woo Park, Suwon-si (KR); Kuk-Hwan Ahn, Hwaseong-si (KR)

(21) Appl. No.: 14/688,964

(22) Filed: Apr. 16, 2015

(30) Foreign Application Priority Data
Nov. 10, 2014 (KR) 10-2014-0155647

(51) Int. Cl. G09G 3/20; G09G 3/36

(52) U.S. Cl. CPC G09G 3/2018; G09G 3/3614; G09G 3/3685; G09G 2320/064; G09G 2310/08; G09G 2320/0285; G09G 2320/0209

(57) ABSTRACT

A method of operating a display panel, the method including obtaining a first total grayscale value associated with a plurality of first subpixel data, the plurality of first subpixel data corresponding to a plurality of first data voltages applied to a plurality of data lines during a first horizontal period, obtaining a second total grayscale value associated with a plurality of second subpixel data, the plurality of second subpixel data corresponding to a plurality of second data voltages applied to the plurality of data lines during a second horizontal period subsequent to the first horizontal period, and selectively compensating the plurality of second subpixel data based on the first total grayscale value and the second total grayscale value.

### CROSS-REFERENCE TO RELATED APPLICATION

This application claims priority to and the benefit of Korean Patent Application No. 10-2014-0155647, filed on Nov. 10, 2014, in the Korean Intellectual Property Office (KIPO), the content of which is herein incorporated by reference in its entirety.

### BACKGROUND

1. Field

Aspects of one or more embodiments of the present invention relate generally to display apparatuses, and more particularly to methods of operating display panels and display apparatuses performing the methods.

2. Description of the Related Art

A liquid crystal display (LCD) apparatus may include a first substrate including a pixel electrode, a second substrate including a common electrode and a liquid crystal layer located between the first and second substrates. An electric field may be generated by voltages applied to the pixel electrode and the common electrode. An intensity of the electric field may be adjusted to control transmittance of light passing through the liquid crystal layer, and thus, a desired image may be displayed.

When the electric field having a uniform direction is continuously applied to the liquid crystal layer, a characteristic of a liquid crystal may be degraded. To reduce or prevent the degradation of the characteristic of the liquid crystal, an inversion driving scheme in which a polarity of a data voltage applied to the liquid crystal is reversed with respect to a common voltage per a set or predetermined period, has been employed. However, in a display panel operating based on the inversion driving scheme, a horizontal crosstalk or a vertical spot line may appear on the display panel depending on an arrangement of pixels in the display panel and/or a variation of grayscale values of an image displayed on the display panel.

### SUMMARY

Accordingly, the present disclosure is provided to substantially obviate one or more problems due to limitations and disadvantages of the related art.

Aspects of one or more example embodiments of the present disclosure are directed toward a method of operating a display panel capable of improving a display quality.

Aspects of one or more example embodiments of the present disclosure are directed toward a display apparatus performing the method of operating the display panel.

According to one or more embodiments of the present disclosure there is provided a method of operating a display panel, the method including: obtaining a first total grayscale value associated with a plurality of first subpixel data, the plurality of first subpixel data corresponding to a plurality of first data voltages applied to a plurality of data lines during a first horizontal period; obtaining a second total grayscale value associated with a plurality of second subpixel data, the plurality of second subpixel data corresponding to a plurality of second data voltages applied to the plurality of data lines during a second horizontal period subsequent to the first horizontal period; and selectively compensating the plurality of second subpixel data based on the first total grayscale value and the second total grayscale value.

In an embodiment, the obtaining of the first total grayscale value includes: generating a first sum grayscale value by adding first grayscale values of a plurality of positive subpixel data from among the plurality of first subpixel data, each of the plurality of positive subpixel data corresponding to a positive data voltage having a positive polarity with respect to a common voltage; generating a second sum grayscale value by adding second grayscale values of a plurality of negative subpixel data from among the plurality of first subpixel data, each of the plurality of negative subpixel data corresponding to a negative data voltage having a negative polarity with respect to the common voltage; and generating the first total grayscale value by subtracting the second sum grayscale value from the first sum grayscale value.

In an embodiment, the obtaining of the second total grayscale value includes: generating a first sum grayscale value by adding first grayscale values of a plurality of positive subpixel data from among the plurality of second subpixel data, each of the plurality of positive subpixel data corresponding to a positive data voltage having a positive polarity with respect to a common voltage; generating a second sum grayscale value by adding second grayscale values of a plurality of negative subpixel data from among the plurality of second subpixel data, each of the plurality of negative subpixel data corresponding to a negative data voltage having a negative polarity with respect to the common voltage; and generating the second total grayscale value by subtracting the second sum grayscale value from the first sum grayscale value.

In an embodiment, the selectively compensating of the plurality of second subpixel data includes: compensating the plurality of second subpixel data based on a first lookup table when a first difference between the first total grayscale value and the second total grayscale value is equal to or greater than a first reference value; and maintaining the plurality of second subpixel data when the first difference is less than the first reference value.

In an embodiment, the compensating of the plurality of second subpixel data based on the first lookup table includes: decreasing a first grayscale value of first positive subpixel data from among the plurality of second subpixel data based on the first lookup table when the first total grayscale value is greater than the second total grayscale value, the first positive subpixel data corresponding to a positive data voltage having a positive polarity with respect to a common voltage; and increasing the first grayscale value based on the first lookup table when the first total grayscale value is less than the second total grayscale value.

In an embodiment, the compensating of the plurality of second subpixel data based on the first lookup table further includes: increasing a second grayscale value of first negative subpixel data from among the plurality of second subpixel data based on the first lookup table when the first total grayscale value is greater than the second total grayscale value, the first negative subpixel data corresponding to a negative data voltage having a negative polarity with respect to the common voltage; and decreasing the second grayscale value based on the first lookup table when the first total grayscale value is less than the second total grayscale value.

In an embodiment, the compensating of the plurality of second subpixel data based on the first lookup table further includes: maintaining the first grayscale value when the first grayscale value corresponds to one of a maximum grayscale value and a minimum grayscale value.

In an embodiment, the selectively compensating of the plurality of second subpixel data includes: compensating the plurality of second subpixel data based on a first lookup table when a first difference between the first total grayscale value and the second total grayscale value is equal to or greater than a first reference value and is less than a second reference value; compensating the plurality of second subpixel data based on a second lookup fable when the first difference is equal to or greater than the second reference value and is less than a third reference value; compensating the plurality of second subpixel data based on a third lookup table when the first difference is equal to or greater than the third reference value; and maintaining the plurality of second subpixel data when the first difference is less than the first reference value.

In an embodiment, the second reference value is greater than the first reference value and is less than the third reference value, wherein a first amount of compensation for the second subpixel data based on the first lookup table is less than a second amount of compensation for the second subpixel data based on the second lookup table, and wherein the second amount of compensation for the second subpixel data based on the second lookup table is less than a third amount of compensation for the second subpixel data based on the third lookup table.

In an embodiment, the display panel includes: a plurality of subpixels; and a plurality of gate lines connected to the plurality of subpixels, wherein a first gate line of the plurality of gate lines is connected to some of first subpixels from among the plurality of subpixels and some of second subpixels from among the plurality of subpixels, the first gate line is enabled during the second horizontal period, the first subpixels are located in a first subpixel row adjacent to the first gate line, and the second subpixels are located in a second subpixel row, the second pixel row being adjacent to the first gate line and different from the first subpixel row.

In an embodiment, a pixel of the display panel includes at least two subpixels located in a same subpixel row and adjacent to one other.

According to one or more embodiments of the present disclosure there is provided a display apparatus including: a display panel including a plurality of subpixels, each of the plurality of subpixels being connected to a respective one of a plurality of gate lines and a respective one of a plurality of data lines; a data driver configured to generate a plurality of first data voltages based on a plurality of first subpixel data to apply the plurality of first data voltages to the plurality of data lines during a first horizontal period, and to generate a plurality of second data voltages based on a plurality of second subpixel data to apply the plurality of second data voltages to the plurality of data lines during a second horizontal period subsequent to the first horizontal period; and a timing controller configured to control an operation of the data driver, to obtain a first total grayscale value associated with the plurality of first subpixel data, to obtain a second total grayscale value associated with the plurality of second subpixel data, and to selectively compensate the plurality of second subpixel data based on the first total grayscale value and the second total grayscale value.

In an embodiment, the timing controller is configured to generate a first sum grayscale value by adding first grayscale values of a plurality of positive subpixel data from among the plurality of first subpixel data, to generate a second sum grayscale value by adding second grayscale values of a plurality of negative subpixel data from among the plurality of first subpixel data, and to generate the first total grayscale value by subtracting the second sum grayscale value from the first sum grayscale value, wherein each of the plurality of positive subpixel data corresponds to a positive data voltage having a positive polarity with respect to a common voltage, and wherein each of the plurality of negative subpixel data corresponds to a negative data voltage having a negative polarity with respect to the common voltage.

In an embodiment, the timing controller is configured to generate a first sum grayscale value by adding first grayscale values of a plurality of positive subpixel data from among the plurality of second subpixel data, to generate a second sum grayscale value by adding second grayscale values of a plurality of negative subpixel data from among the plurality of second subpixel data, and to generate the second total grayscale value by subtracting the second sum grayscale value from the first sum grayscale value, wherein each of the plurality of positive subpixel data corresponds to a positive data voltage having a positive polarity with respect to a common voltage, and wherein each of the plurality of negative subpixel data corresponds to a negative data voltage having a negative polarity with respect to the common voltage.

In an embodiment, the timing controller is configured to compensate the plurality of second subpixel data based on a first lookup table when a first difference between the first total grayscale value and the second total grayscale value is equal to or greater than a first reference value, and to maintain the plurality of second subpixel data when the first difference is less than the first reference value.

In an embodiment, the timing controller is configured to decrease a first grayscale value of first positive subpixel data from among the plurality of second subpixel data based on the first lookup table when the first total grayscale value is greater than the second total grayscale value, and to increase the first grayscale value based on the first lookup table when the first total grayscale value is less than the second total grayscale value, and wherein the first positive subpixel data corresponds to a positive data voltage having a positive polarity with respect to a common voltage.

In an embodiment, the timing controller is configured to increase a second grayscale value of first negative subpixel data from among the plurality of second subpixel data based on the first lookup table when the first total grayscale value is greater than the second total grayscale value, and to decrease the second grayscale value based on the first lookup table when the first total grayscale value is less than the second total grayscale value, and wherein the first negative subpixel data corresponds to a negative data voltage having a negative polarity with respect to the common voltage.

In an embodiment, the timing controller is configured to maintain the first grayscale value when the first grayscale value corresponds to one of a maximum grayscale value and a minimum grayscale value.

In an embodiment, the timing controller is configured to compensate the plurality of second subpixel data based on a first lookup table when a first difference between the first total grayscale value and the second total grayscale value is equal to or greater than a first reference value and is less than a second reference value, to compensate the plurality of second subpixel data based on a second lookup table when the first difference is equal to or greater than the second reference value and is less than a third reference value, to compensate the plurality of second subpixel data based on a third lookup table when the first difference is equal to or greater than the third reference value, and to maintain the plurality of second subpixel data when the first difference is less than the first reference value.

In an embodiment, the second reference value is greater than the first reference value and is less than the third reference value, wherein a first amount of compensation for the second subpixel data based on the first lookup table is less than a second amount of compensation for the second subpixel data based on the second lookup table, and wherein the second amount of compensation for the second subpixel data based on the second lookup table is less than a third amount of compensation for the second subpixel data based on the third lookup table.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a display apparatus according to some example embodiments.

FIG. 2 is a block diagram illustrating an example of a timing controller included in the display apparatus of FIG. 1.

FIG. 3 is a plan view illustrating an example of a display panel included in the display apparatus of FIG. 1.

FIG. 4 is a plan view illustrating another example of the display panel included in the display apparatus of FIG. 1.

FIG. 5 is a flow chart illustrating a method of operating a display panel according to some example embodiments.

FIG. 6 is a flow chart illustrating an example of obtaining a first total grayscale value in FIG. 5.

FIG. 7 is a flow chart illustrating an example of obtaining a second total grayscale value in FIG. 5.

FIG. 8 is a flow chart illustrating an example of selectively compensating a plurality of second subpixel data in FIG. 5.

FIG. 9 is a flow chart illustrating an example of compensating the plurality of second subpixel data based on a first lookup table in FIG. 8.

FIGS. 10, 11A, 11B, 12A, and 12B are diagrams for describing a compensation operation in FIGS. 8 and 9.

FIG. 13 is a flow chart illustrating another example of selectively compensating the plurality of second subpixel data in FIG. 5.

FIGS. 14 and 15 are diagrams for describing a compensation operation in FIG. 13.

### DETAILED DESCRIPTION

Various example embodiments will be described more fully with reference to the accompanying drawings, in which embodiments are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. Like reference numerals refer to like elements throughout this application.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent to” another element or layer, it can be directly on, connected to, coupled to, or adjacent to the other element or layer, or one or more intervening elements or layers may be present. When an element or layer is referred to as being “directly on,” “directly connected to”, “directly coupled to”, or “immediately adjacent to” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. §112, first paragraph, and 35 U.S.C. §132(a).

The display apparatus and/or any other relevant devices or components according to embodiments of the present invention described herein may be implemented utilizing any suitable hardware, firmware (e.g. an application-specific integrated circuit), software, or a suitable combination of software, firmware, and hardware. For example, the various components of the display apparatus may be formed on one integrated circuit (IC) chip or on separate IC chips. Further, the various components of the display apparatus may be implemented on a flexible printed circuit film, a tape carrier package (TCP), a printed circuit board (PCB), or formed on a same substrate as the display apparatus. Further, the various components of the display apparatus may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

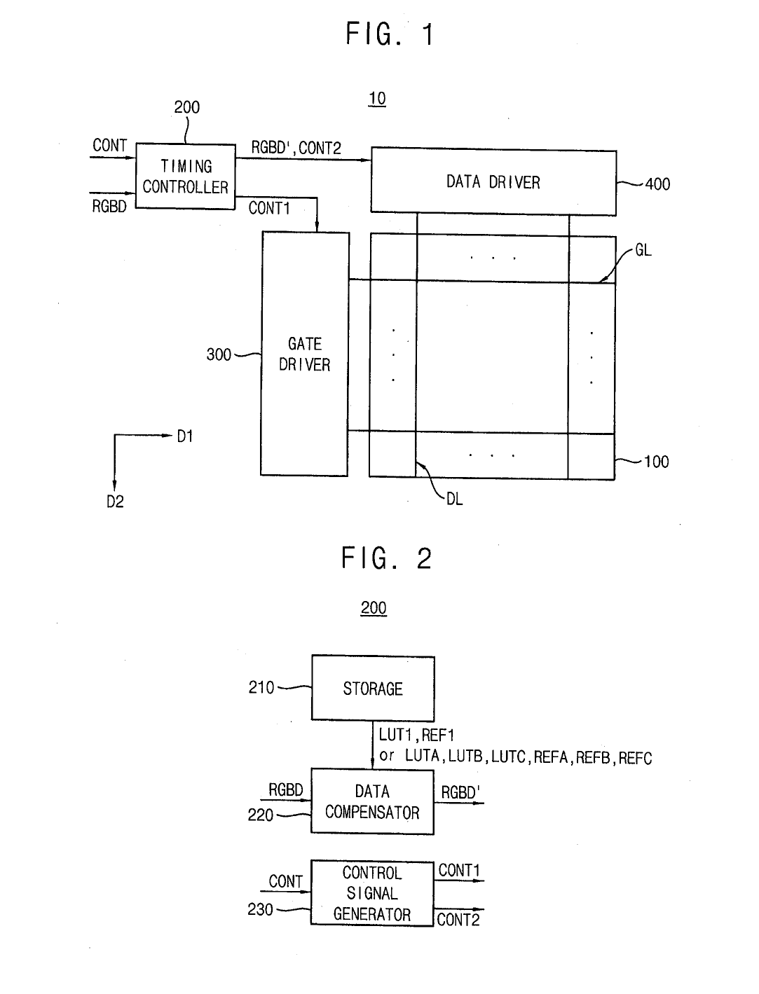

FIG. 1 is a block diagram illustrating a display apparatus according to some example embodiments.

Referring to FIG. 1, a display apparatus 10 includes a display panel 100, a timing controller 200, a gate driver 300, and a data driver 400.

The display panel 100 is connected to a plurality of gate lines GL and a plurality of data lines DL. The display panel 100 displays an image having a plurality of grayscale values based on output image data RGBD′. The gate lines GL may extend in a first direction D1, and the data lines DL may extend in a second direction D2 crossing (e.g., substantially perpendicular to) the first direction D1.

The display panel 100 may include a plurality of pixels that are arranged in a grid or matrix form. Each pixel may be electrically connected to a respective one of the gate lines GL and a respective one of the data lines DL. Each pixel may include at least two subpixels.

Each pixel may include a switching element, a liquid crystal capacitor and a storage capacitor. The liquid crystal capacitor and the storage capacitor may be electrically connected to the switching element. For example, the switching element may be a thin film transistor. The liquid crystal capacitor may include a first electrode connected to a pixel electrode and a second electrode connected to a common electrode. A data voltage may be applied to the first electrode of the liquid crystal capacitor. A common voltage may be applied to the second electrode of the liquid crystal capacitor. The storage capacitor may include a first electrode connected to the pixel electrode and a second electrode connected to a storage electrode. The data voltage may be applied to the first electrode of the storage capacitor. A storage voltage may be applied to the second electrode of the storage capacitor. The storage voltage may be substantially equal to the common voltage.

Each pixel may have a rectangular shape. For example, each pixel may have a relatively short side in the first direction D1 and a relatively long side in the second direction D2. The relatively short side of each pixel may be substantially parallel to the gate lines GL. The relatively long side of each pixel may be substantially parallel to the data lines DL.

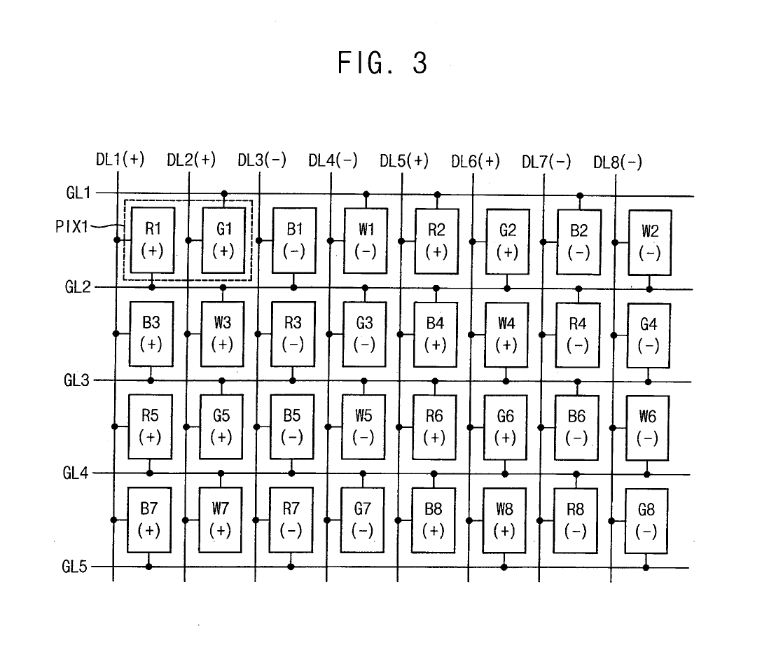

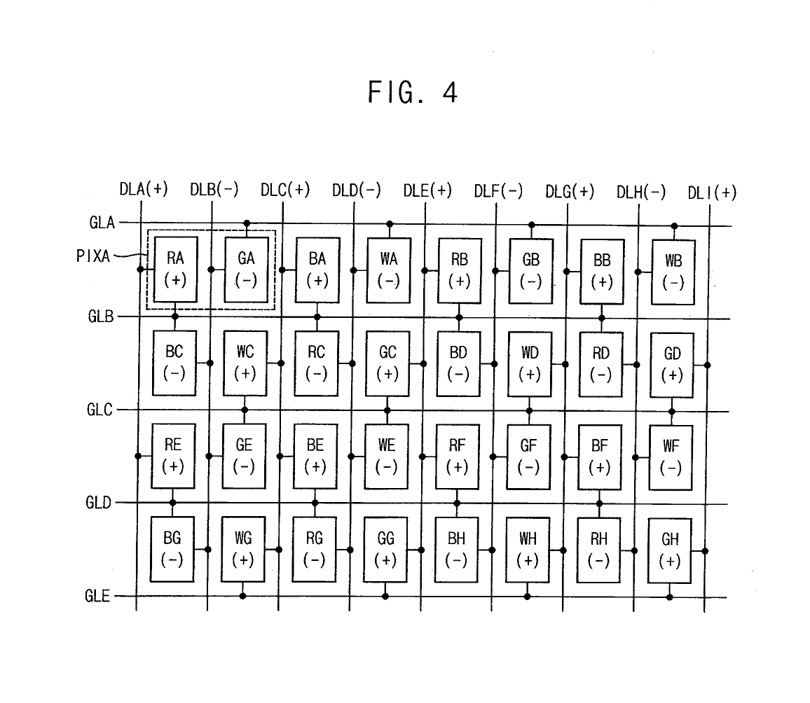

Detailed configurations of the pixels and the subpixels will be described below with reference to FIGS. 3 and 4.

The timing controller 200 controls an operation of the display panel 100 and controls operations of the gate driver 300 and the data driver 400. The timing controller 200 receives input image data RGBD and an input control signal CONT from an external device (e.g., a host). The input image data RGBD may include a plurality of input pixel data for the plurality of pixels. Each input pixel data may include red grayscale data R, green grayscale data G and blue grayscale data B for a respective one of the plurality of pixels. The input control signal CONT may include a master clock signal, a data enable signal, a vertical synchronization signal, a horizontal synchronization signal, etc.

The timing controller 200 generates the output image data RGBD′, a first control signal CONT1 and a second control signal CONT2 based on the input image data RGBD and the input control signal CONT.

For example, the timing controller 200 may generate the output image data RGBD′ based on the input image data RGBD. The output image data RGBD′ may be provided to the data driver 400. In some example embodiments, the output image data RGBD′ may be image data that is substantially the same as the input image data RGBD. In other example embodiments, the output image data RGBD′ may be compensated image data that is generated by compensating the input image data RGBD. Similarly to the input image data RGBD, the output image data RGBD′ may include a plurality of output pixel data for the plurality of pixels.

The timing controller 200 may generate the first control signal CONT1 based on the input control signal CONT. The first control signal CONT1 may be provided to the gate driver 300, and a drive timing of the gate driver 300 may be controlled based on the first control signal CONT1. The first control signal CONT1 may include a vertical start signal, a gate clock signal, etc. The timing controller 200 may generate the second control signal CONT2 based on the input control signal CONT. The second control signal CONT2 may be provided to the data driver 400, and a drive timing of the data driver 400 may be controlled based on the second control signal CONT2. The second control signal CONT2 may include a horizontal start signal, a data clock signal, a data load signal, a polarity control signal, etc.

In addition, the timing controller 200 obtains a first total grayscale value associated with a plurality of first subpixel data and a second total grayscale value associated with a plurality of second subpixel data, and selectively compensates the plurality of second subpixel data based on the first and second total grayscale values. The plurality of first subpixel data may be data for generating a plurality of first data voltages that are applied to the plurality of data lines DL during a first horizontal period. The plurality of second subpixel data may be data for generating a plurality of second data voltages that are applied to the plurality of data lines DL during a second horizontal period subsequent to the first horizontal period. For example, the first horizontal period may correspond to a previous horizontal period, the second horizontal period may correspond to a present horizontal period, the plurality of first subpixel data may correspond to previous subpixel data, and the plurality of second subpixel data may correspond to present subpixel data.

Detailed configurations and operations of the timing controller 200 will be described below with reference to FIGS. 2 and 5 through 15.

The gate driver 300 receives the first control signal CONT1 from the timing controller 200. The gate driver 300 generates a plurality of gate signals for driving the gate lines GL based on the first control signal CONT1. The gate driver 300 may sequentially apply the plurality of gate signals to the gate lines GL.

The data driver 400 receives the second control signal CONT2 and the output image data RGBD′ from the timing controller 200. The data driver 400 generates a plurality of data voltages (e.g., analog data voltages) based on the second control signal CONT2 and the output image data RGBD′ (e.g., digital image data). The data driver 400 may apply the plurality of data voltages to the data lines DL. For example, the data driver 400 may generate the plurality of first data voltages based on the plurality of first subpixel data to apply the plurality of first data voltages to the plurality of data lines DL during the first horizontal period, and may generate the plurality of second data voltages based on the plurality of second subpixel data to apply the plurality of second data voltages to the plurality of data lines DL during the second horizontal period.

In some example embodiments, the data driver 400 may include a shift register, a latch, a signal processor and a buffer. The shift register may output a latch pulse to the latch. The latch may temporarily store the output image data RGBD′, and may output the output image data RGBD′ to the signal processor. The signal processor may generate the analog data voltages based on the digital output image data RGBD′ and may output the analog data voltages to the buffer. The buffer may output the analog data voltages to the data lines DL.

In some example embodiments, the gate driver 300 and/or the data driver 400 may be located, e.g., directly mounted, on the display panel 100, or may be connected to the display panel 100 in a tape carrier package (“TCP”) type (or kind). Alternatively, the gate driver 300 and/or the data driver 400 may be integrated on the display panel 100.

FIG. 2 is a block diagram illustrating an example of a timing controller included in the display apparatus of FIG. 1.

Referring to FIG. 2, the timing controller 200 may include a storage 210, a data compensator 220 and a control signal generator 230. The timing controller 200 is illustrated as being divided into three elements for convenience of explanation, however, the timing controller 200 may not be physically divided.

The storage 210 may store lookup tables LUT1, LUTA, LUTB, and LUTC and reference values REF1, REFA, REFB, and REFC that are used for compensating the input image data RGBD. For example, the storage 210 may include at least one nonvolatile memory, such as an erasable programmable read-only memory (EPROM), an electrically erasable programmable read-only memory (EEPROM), a flash memory, a phase change random access memory (PRAM), a resistance random access memory (RRAM), a magnetic random access memory (MRAM), a ferroelectric random access memory (FRAM), a nano floating gate memory (NFGM), a polymer random access memory (PoRAM), etc.

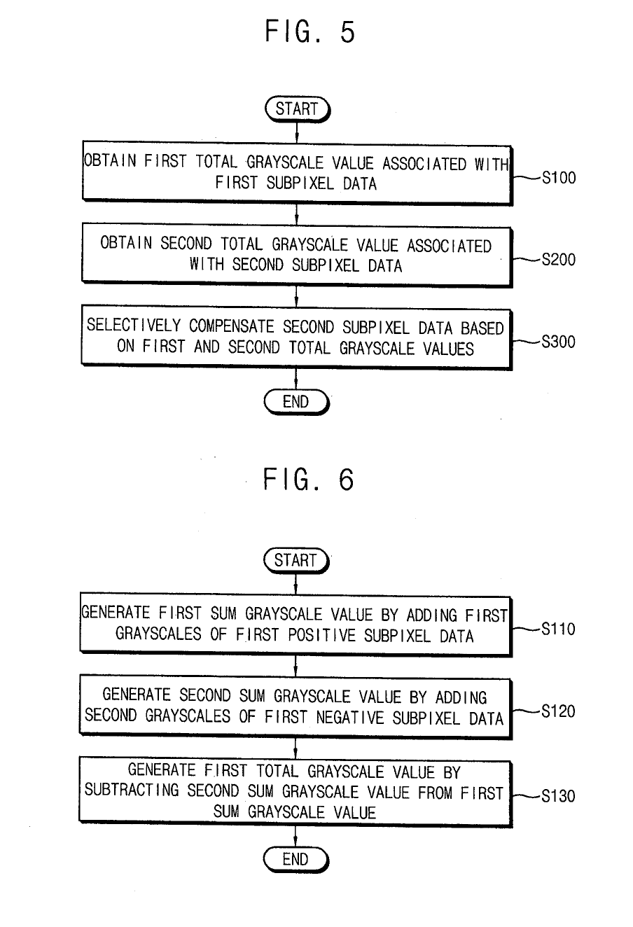

The data compensator 220 may receive the input image data RGBD from the external device and may generate the output image data RGBD′ by selectively compensating the input image data RGBD. For example, as described above with reference to FIG. 1, the input image data RGBD may include the plurality of input pixel data for the plurality of pixels. The plurality of input pixel data may include the plurality of first subpixel data and the plurality of second subpixel data. As will be described below with reference to FIG. 5, the data compensator 220 may obtain the first total grayscale value associated with the plurality of first subpixel data and the second total grayscale value associated with the plurality of second subpixel data. The data compensator 220 may selectively compensate the plurality of second subpixel data based on the first and second total grayscale values, at least one selected from the lookup tables LUT1, LUTA, LUTB, and LUTC, and at least one selected from the reference values REF1, REFA, REFB, and REFC.

In some example embodiments, the data compensator 220 may further perform an image quality compensation, a spot compensation, an adaptive color correction (ACC), and/or a dynamic capacitance compensation (DCC) for the input image data RGBD to generate the output image data RGBD′.

In some example embodiments, the data compensator 220 may include a single-line memory that stores subpixel data corresponding to a single subpixel row (e.g., a single horizontal line).

The control signal generator 230 may receive the input control signal CONT from the external device and may generate the first control signal CONT1 for the gate driver 300 and the second control signal CONT2 for the data driver 400 based on the input control signal CONT. The control signal generator 230 may output the first control signal CONT1 to the gate driver 300 and may output the second control signal CONT2 to the data driver 400.

FIG. 3 is a plan view illustrating an example of a display panel included in the display apparatus of FIG. 1.

Referring to FIG. 3, a display panel may include the plurality of subpixels R1˜R8, G1˜G8, B1˜B8, and W1˜W8. The subpixels R1˜R8 may be red subpixels. The subpixels G1˜G8 may be green subpixels. The subpixels B1˜B8 may be blue subpixels. The subpixels W1˜W8 may be white subpixels.

Each of the plurality of subpixels R1˜R8, G1˜G8, B1˜B8, and W1˜W8 may be located in a respective one of a plurality of subpixel rows and a respective one of a plurality of subpixel columns.

For example, the subpixels R1, B3, R5, and B7 may be located in a first subpixel column. The subpixels G1, W3, G5, and W7 may be located in a second subpixel column. The subpixels B1, R3, B5, and R7 may be located in a third subpixel column. The subpixels W1, G3, W5, and G7 may be located in a fourth subpixel column. The subpixels R2, B4, R6, and B8 may be located in a fifth subpixel column. The subpixels G2, W4, G6, and W8 may be located in a sixth subpixel column. The subpixels B2, R4, B6, and R8 may be located in a seventh subpixel column. The subpixels W2, G4, W6, and G8 may be located in an eighth subpixel column.

The subpixels R1, G1, B1, W1, R2, G2, B2, and W2 may be located in a first subpixel row. The subpixels B3, W3, R3, G3, B4, W4, R4, and G4 may be located in a second subpixel row. The subpixels R5, G5, B5, W5, R6, G6, B6, and W6 may be located in a third subpixel row. The subpixels B7, W7, R7, G7, B8, W8, R8, and G8 may be located in a fourth subpixel row.

In addition, each of the plurality of subpixels R1˜R8, G1˜G8, B1˜B8, and W1˜W8 may be connected to a respective one of a plurality of gate lines GL1˜GL5 and a respective one of a plurality of data lines DL1˜DL8. A single gate line may be connected to some of subpixels in two subpixel rows that are adjacent to each other and are adjacent to the single gate line. A single data line may be connected to subpixels in a single subpixel column that is located at a right side of the single data line.

For example, the subpixels G1, W1, R2, and B2 may be connected to the first gate line GL1. The subpixels R1, B1, G2, W2, W3, G3, B4, and R4 may be connected to the second gate line GL2. The subpixels B3, R3, W4, G4, G5, W5, R6, and B6 may be connected to the third gate line GL3. The subpixels R5, B5, G6, W6, W7, G7, B8, and R8 may be connected to the fourth gate line GL4. The subpixels B7, R7, W8, and G8 may be connected to the fifth gate line GL5.

The subpixels R1, B3, R5, and B7 may be connected to the first data line DL1. The subpixels G1, W3, G5, and W7 may be connected to the second data line DL2. The subpixels B1, R3, B5, and R7 may be connected to the third data line DL3. The subpixels W1, G3, W5, and G7 may be connected to the fourth data line DL4. The subpixels R2, B4, R6, and B8 may be connected to the fifth data line DL5. The subpixels G2, W4, G6, and W8 may be connected to the sixth data line DL6. The subpixels B2, R4, B6, and R8 may be connected to the seventh data line DL7. The subpixels W2, G4, W6, and G8 may be connected to the eighth data line DL8.

Data voltages (e.g., analog data voltage signals) may be applied to the data lines DL1˜DL8 in a frame. Polarities of the data voltages may be inverted in a next frame.

For example, during a first frame, data voltages having a positive polarity (+) may be applied to the first, second, fifth, and sixth data lines DL1, DL2, DL5, and DL6, and data voltages having a negative polarity (−) may be applied to the third, fourth, seventh, and eighth data lines DL3, DL4, DL7, and DL8. Each of the first through fourth subpixel rows may have a polarity pattern of “+, +, −, −, +, +, −, −”. Therefore, the display panel may have a polarity pattern of a line inversion (e.g., a column inversion) where subpixels in two adjacent subpixel columns have the same polarity as each other.

During a second frame subsequent to the first frame, data voltages having the negative polarity (−) may be applied to the first, second, fifth, and sixth data lines DL1, DL2, DL5, and DL6, and data voltages having the positive polarity (+) may be applied to the third, fourth, seventh, and eighth data lines DL3, DL4, DL7, and DL8. As explained above, the display panel may have a polarity pattern of a line inversion. Each of the first through fourth subpixel rows may have a polarity pattern of “−, −, +, +, −, −, +, +”.

FIG. 4 is a plan view illustrating another example of the display panel included in the display apparatus of FIG. 1.

Referring to FIG. 4, a display panel may include the plurality of subpixels RA˜RH, GA˜GH, BA˜BH, and WA˜WH. The subpixels RA˜RH may be red subpixels. The subpixels GA˜GH may be green subpixels. The subpixels BA˜BH may be blue subpixels. The subpixels WA˜WH may be white subpixels.

Each of the plurality of subpixels RA˜RH, GA˜GH, BA˜BH, and WA˜WH may be located in a respective one of a plurality of subpixel rows and a respective one of a plurality of subpixel columns.

For example, the subpixels RA, BC, RE, and BG may be located in a first subpixel column. The subpixels GA, WC, GE, and WG may be located in a second subpixel column. The subpixels BA, RC, BE, and RG may be located in a third subpixel column. The subpixels WA, GC, WE, and GG may be located in a fourth subpixel column. The subpixels RB, BD, RF, and BH may be located in a fifth subpixel column. The subpixels GB, WD, GF, and WH may be located in a sixth subpixel column. The subpixels BB, RD, BF, and RH may be located in a seventh subpixel column. The subpixels WB, GD, WF, and GH may be located in an eighth subpixel column.

The subpixels RA, GA, BA, WA, RB, GB, BB, and WB may be located in a first subpixel row. The subpixels BC, WC, RC, GC, BD, WD, RD, and GD may be located in a second subpixel row. The subpixels RE, GE, BE, WE, RF, GF, BF, and WF may be located in a third subpixel row. The subpixels BG, WG, RG, GG, BH, WH, RH, and GH may be located in a fourth subpixel row.

In addition, each of the plurality of subpixels RA˜RH, GA˜GH, BA˜BH, and WA˜WH may be connected to a respective one of a plurality of gate lines GLA˜GLE and a respective one of a plurality of data lines DLA˜DLI. A single gate line may be connected to some of subpixels in two subpixel rows that are adjacent to each other and are adjacent to the single gate line. A single data line may be connected to some of subpixels in two subpixel columns that are adjacent to each other and are adjacent to the single data line.

For example, the subpixels GA, WA, GB, and WB may be connected to the first gate line GLA. The subpixels RA, BA, RB, BB, BC, RC, BD, and RD may be connected to the second gate line GLB. The subpixels WC, GC, WD, GD, GE, WE, GF, and WF may be connected to the third gate line GLC. The subpixels RE, BE, RF, BF, BG, RG, BH, and RH may be connected to the fourth gate line GLD. The subpixels WG, GG, WH, and GH may be connected to the fifth gate line GLE. In other words, the second gate line GLB may be connected to odd-numbered subpixels in the first and second subpixel rows, and the third gate line GLC may be connected to even-numbered subpixels in the second and third subpixel rows.

The subpixels RA and RE may be connected to the first data line DLA. The subpixels GA, BC, GE, and BG may be connected to the second data line DLB. The subpixels BA, WC, BE, and WG may be connected to the third data line DLC. The subpixels WA, RC, WE, and RG may be connected to the fourth data line DLD. The subpixels RB, GC, RF, and GG may be connected to the fifth data line DLE. The subpixels GB, BD, GF, and BH may be connected to the sixth data line DLF. The subpixels BB, WD, BF, and WH may be connected to the seventh data line DLG. The subpixels WB, RD, WF, and RH may be connected to the eighth data line DLH. The subpixels GD and GH may be connected to the ninth data line DLI.

Data voltages (e.g., analog data voltage signals) may be applied to the data lines DLA˜DLI in a frame. Polarities of the data voltages may be inverted in a next frame.

For example, during a first frame, data voltages having a positive polarity (+) may be applied to the first, third, fifth, seventh, and ninth data lines DLA, DLC, DLE, DLG, and DLI, and data voltages having a negative polarity (−) may be applied to the second, fourth, sixth, and eighth data lines DLB, DLD, DLF, and DLH. Accordingly, data voltages applied to subpixels of the display panel may be inverted in polarity for each row (e.g., referred to as a polarity pattern of a dot inversion). For example, each of the first and third subpixel rows may have a polarity pattern of “+, −, +, −, +, −, +, −”, and each of the second and fourth subpixel rows may have a polarity pattern of “−, +, −, +, −, +, −, +,” which is opposite to that of each of the first and third subpixel rows. Therefore, the display panel may have a polarity pattern of a dot inversion where a single subpixel is surrounded by subpixels having a polarity, which is opposite to that of the single subpixel.

During a second frame subsequent to the first frame, data voltages having the negative polarity (−) may be applied to the first, third, fifth, seventh and ninth data lines DLA, DLC, DLE, DLG, and DLI, and data voltages having the positive polarity (+) may be applied to the second, fourth, sixth, and eighth data lines DLB, DLD, DLF, and DLH. As explained above, the display panel may have a polarity pattern of a dot inversion. Each of the first and third subpixel rows may have a polarity pattern of “−, +, −, +, −, +, −, +”, and each of the second and fourth subpixel rows may have a polarity pattern of “+, −, +, −, +, −, +, −,” which is opposite to that of each of the first and third subpixel rows.

Thus, using a column inversion scheme, which provides data voltages having opposite polarities to adjacent data lines, the display panel may have a dot inversion effect in which subpixels are inverted in polarity for every column in the first direction D1 (e.g., in a row direction) and subpixels are inverted in polarity for every row in the second direction D2 (e.g., in a column direction).

In the examples of FIGS. 3 and 4, a pixel of the display panel may include at least two subpixels that are located in a same subpixel row and are adjacent to each other. For example, the subpixels R1 and G1 in FIG. 3 may form a pixel PIX1, and the subpixels RA and GA in FIG. 4 may form a pixel PIXA. The subpixels B1 and W1 in FIG. 3 may form another pixel, and the subpixels BA and WA in FIG. 4 may form another pixel.

The display panels of FIGS. 3 and 4 may operate based on a horizontal alternate driving (HAD) scheme, which is one of inversion driving schemes. In the display panel of FIG. 3, some subpixels G1, W1, R2, and B2 in a single subpixel row (e.g., the first subpixel row) may be driven based on one gate line GL1, and the other subpixels R1, B1, G2, and W2 in the single subpixel row may be driven based on another gate line GL2. A single gate line GL2 in FIG. 3 may drive one (e.g., the subpixel R1) of two adjacent subpixels R1 and B3 in a single subpixel column. In the display panel of FIG. 4, some subpixels GA, WA, GB and WB in a single subpixel row (e.g., the first subpixel row) may be driven based on one gate line GLA, and the other subpixels RA, BA, RB, and BB in the single subpixel row may be driven based on another gate line GLB. A single gate line GLB in FIG. 4 may drive two adjacent subpixels RA and BC in a single subpixel column.

Hereinafter, the method of operating the display panel according to some example embodiments will be described based on the display panel driven by the HAD scheme. However, the method of operating the display panel according to some example embodiments may be used in a display panel driven by any inversion driving scheme.

FIG. 5 is a flow chart illustrating a method of operating a display panel according to some example embodiments.

Referring to FIGS. 1 and 5, in the method of operating the display panel 100 according to some example embodiments, a first total grayscale value associated with a plurality of first subpixel data is obtained (block S100). A second total grayscale value associated with a plurality of second subpixel data is obtained (block S200). As described above with reference to FIG. 1, the plurality of first subpixel data may be data for generating a plurality of first data voltages that are applied to the plurality of data lines DL during a first horizontal period. The plurality of second subpixel data may be data for generating a plurality of second data voltages that are applied to the plurality of data lines DL during a second horizontal period subsequent to the first horizontal period. One horizontal period may correspond to a period during which one gate line is enabled.

In some example embodiments, when the display panel 100 has the configuration illustrated in FIG. 3, the sequence of enabling the gate lines may be, but is not limited to, GL2→GL4→GL1→GL3. In this case, the first horizontal period may represent a period during which the second gate line GL2 is enabled, and the plurality of first subpixel data may be data for driving the subpixels R1, B1, G2, W2, W3, G3, B4, and R4 that are connected to the second gate line GL2. The second horizontal period may represent a period during which the fourth gate line GL4 is enabled, and the plurality of second subpixel data may be data for driving the subpixels R5, B5, G6, W6, W7, G7, B8, and R8 that are connected to the fourth gate line GL4.

In other example embodiments, when the display panel 100 has the configuration illustrated in FIG. 4, the sequence of enabling the gate lines may be, but is not limited to, GLB→GLD→GLA→GLC. In this case, the first horizontal period may represent a period during which the second gate line GLB is enabled, and the plurality of first subpixel data may be data for driving the subpixels RA, BA, RB, BB, BC, RC, BD, and RD that are connected to the second gate line GLB. The second horizontal period may represent a period during which the fourth gate line GLD is enabled, and the plurality of second subpixel data may be data for driving the subpixels RE, BE, RF, BF, BG, RG, BH, and RH that are connected to the fourth gate line GLD.

The plurality of second subpixel data is selectively compensated based on the first total grayscale value and the second total grayscale value (block S300).

During the second horizontal period, a portion of an image may be displayed on the display panel 100 based on the plurality of second subpixel data.

Blocks S100, S200, and S300 in FIG. 5 may be performed by the timing controller 200. For example, blocks S100, S200, and S300 in FIG. 5 may be performed by the data compensator 220 in FIG. 2.

Blocks S100, S200, and S300 in FIG. 5 may be repeated for a plurality of horizontal periods in a single image frame and for a plurality of subpixel data corresponding to the plurality of horizontal periods.

FIG. 6 is a flow chart illustrating an example of obtaining a first total grayscale value in FIG. 5.

Referring to FIGS. 5 and 6, in block S100, a first sum grayscale value may be generated by adding first grayscale values of a plurality of first positive subpixel data among the plurality of first subpixel data (block S110). Each of the plurality of first positive subpixel data may correspond to a positive data voltage that has a positive polarity with respect to a common voltage. A second sum grayscale value may be generated by adding second grayscale values of a plurality of first negative subpixel data among the plurality of first subpixel data (block S120). Each of the plurality of first negative subpixel data may correspond to a negative data voltage that has a negative polarity with respect to the common voltage. The first total grayscale value may be generated by subtracting the second sum grayscale value from the first sum grayscale value (block S130).

In some example embodiments, when the display panel 100 has the configuration illustrated in FIG. 3, the plurality of first positive subpixel data may correspond to the data lines DL1, DL2, DL5, and DL6 (e.g., may correspond to the subpixels R1, W3, B4, and G2), and the plurality of first negative subpixel data may correspond to the data lines DL3, DL4, DL7, and DL8 (e.g., may correspond to the subpixels B1, G3, R4, and W2).

In other example embodiments, when the display panel 100 has the configuration illustrated in FIG. 4, the plurality of first positive subpixel data may correspond to the data lines DLA, DLC, DLE, DLG, and DLI (e.g., may correspond to the subpixels RA, BA, RB, and BB), and the plurality of first negative subpixel data may correspond to the data lines DLB, DLD, DLF, and DLH (e.g., may correspond to the subpixels BC, RC, BD, and RD).

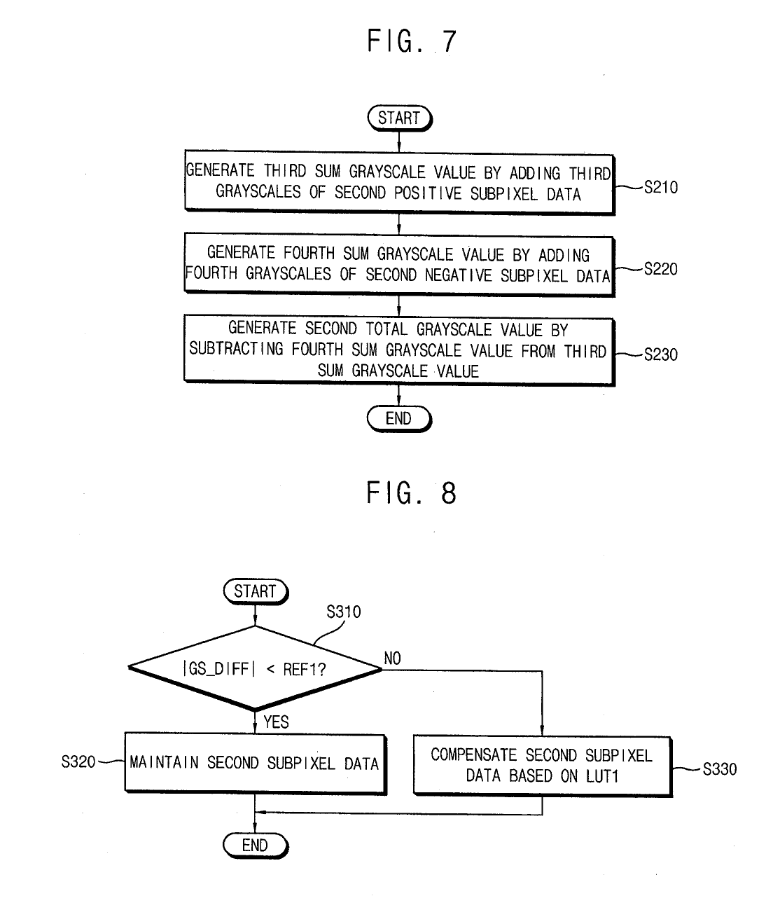

FIG. 7 is a flow chart illustrating an example of obtaining a second total grayscale value in FIG. 5.

Referring to FIGS. 5 and 7, in block S200, a third sum grayscale value may be generated by adding third grayscale values of a plurality of second positive subpixel data among the plurality of second subpixel data (block S210). Each of the plurality of second positive subpixel data may correspond to a positive data voltage that has a positive polarity with respect to the common voltage. A fourth sum grayscale value may be generated by adding fourth grayscale values of a plurality of second negative subpixel data among the plurality of second subpixel data (block S220). Each of the plurality of second negative subpixel data may correspond to a negative data voltage that has a negative polarity with respect to the common voltage. The second total grayscale value may be generated by subtracting the fourth sum grayscale value from the third sum grayscale value (block S230).

In some example embodiments, when the display panel 100 has the configuration illustrated in FIG. 3, the plurality of second positive subpixel data may correspond to the data lines DL1, DL2, DL5, and DL6 (e.g., may correspond to the subpixels R5, W7, B8, and G6), and the plurality of second negative subpixel data may correspond to the data lines DL3, DL4, DL7, and DL8 (e.g., may correspond to the subpixels B5, G7, R8, and W6).

In other example embodiments, when the display panel 100 has the configuration illustrated in FIG. 4, the plurality of second positive subpixel data may correspond to the data lines DLA, DLC, DLE, DLG, and DLI (e.g., may correspond to the subpixels RE, BE, RF, and BF), and the plurality of second negative subpixel data may correspond to the data lines DLB, DLD, DLF, and DLH (e.g., may correspond to the subpixels BG, RG, BH, and RH).

FIG. 8 is a flow chart illustrating an example of selectively compensating a plurality of second subpixel data in FIG. 5.

Referring to FIGS. 5 and 8, in block S300, a first difference GS_DIFF between the first total grayscale value and the second total grayscale value may be compared with a first reference value REF1 (block S310). When the first difference GS_DIFF is less than the first reference value REF1 (block S310: YES), the plurality of second subpixel data may be maintained (block S320). When the first difference GS_DIFF is equal to or greater than the first reference value REF1 (block S310: NO), the plurality of second subpixel data may be compensated based on a first lookup table LUT1 (block S330).

In some example embodiments, the first reference value REF1 may be represented by Equation 1 and Equation 2.

REF1=DSMAX/2 Equation 1

DSMAX=GN*RESOL*SN/2 Equation 2

In the Equations 1 and 2, GN represents the number of grayscale values capable of being displayed by the display panel, RESOL represents a horizontal resolution of the display panel, and SN represents the number of subpixels included in one pixel of the display panel. For example, when the display panel is an Ultra High Definition (UHD) Green Display Panel, GN may be about 255, RESOL may be about 3840, and SN may be about 2.

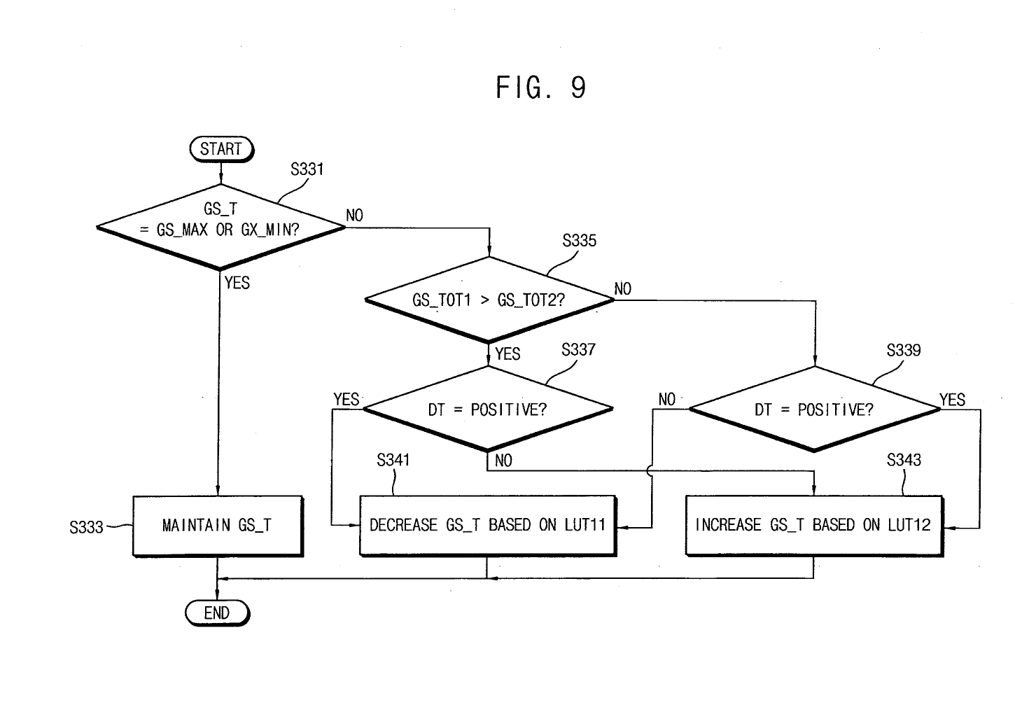

FIG. 9 is a flow chart illustrating an example of compensating the plurality of second subpixel data based on a first lookup table in FIG. 8.

Referring to FIGS. 8 and 9, in block S330, it may be determined whether a grayscale value GS_T of first data DT among the plurality of second subpixel data corresponds to one of a maximum grayscale value GS_MAX and a minimum grayscale value GS_MIN (block S331).

When the grayscale value GS_T of the first data DT corresponds to one of the maximum grayscale value GS_MAX and the minimum grayscale value GS_MIN (block S331: YES), the grayscale value GS_T of the first data DT may be maintained (block S333).

When the grayscale value GS_T of the first data DT does not correspond to one of the maximum grayscale value GS_MAX and the minimum grayscale value GS_MIN (block S331: NO), the grayscale value GS_T of the first data DT may increase or may decrease based on the first lookup table LUT1 and a polarity of the first data DT.

For example, when the first total grayscale value GS_TOT1 is greater than the second total grayscale value GS_TOT2 (e.g., when the second total grayscale value GS_TOT2 decreases from the first total grayscale value GS_TOT1) (block S335: YES), and when the first data DT is a positive type (e.g., when a data voltage generated based on the first data DT has a positive polarity) (block S337: YES), the grayscale value GS_T of the first data DT may decrease based on a first decremental lookup table LUT11 of the first lookup table LUT1 (block S341). When the first total grayscale value GS_TOT1 is greater than the second total grayscale value GS_TOT2 (block S335: YES), and when the first data DT is a negative type (e.g., when the data voltage generated based on the first data DT has a negative polarity) (block S337: NO), the grayscale value GS_T of the first data DT may increase based on a first incremental lookup table LUT12 of the first lookup table LUT1 (block S343).

When the first total grayscale value GS_TOT1 is less than the second total grayscale value GS_TOT2 (e.g., when the second total grayscale value GS_TOT2 increases from the first total grayscale value GS_TOT1) (block S335: NO), and when the first data DT is the positive type (block S339: YES), the grayscale value GS_T of the first data DT may increase based on the first incremental lookup table LUT12 (block S343). When the first total grayscale value GS_TOT1 is less than the second total grayscale value GS_TOT2 (block S335: NO), and when the first data DT is the negative type (block S339: NO), the grayscale value GS_T of the first data DT may decrease based on the first decremental lookup table LUT11 (block S341).

Blocks S331, S333, S335, S337, S339, S341 and S343 in FIG. 9 may be repeated for all of the plurality of second subpixel data.

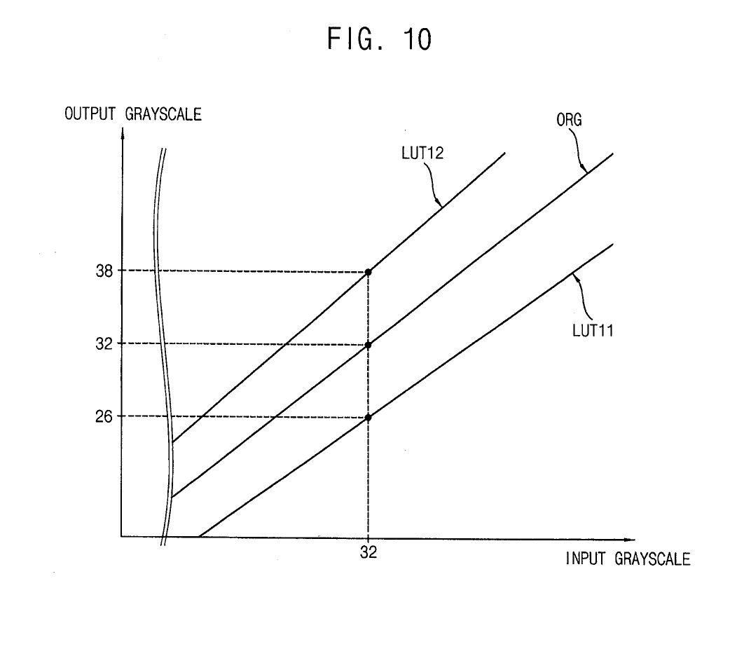

FIGS. 10, 11A, 11B, 12A, and 12B are diagrams for describing a compensation operation in FIGS. 8 and 9.

FIG. 10 is a graph illustrating an example of the first lookup table LUT1 that is used for performing the compensation operation in FIGS. 8 and 9. In FIG. 10, ORG represents a relationship between an input grayscale value and an output grayscale value when the compensation operation is not performed, LUT11 represents a relationship between an input grayscale value and an output grayscale value when the compensation operation is performed based on the first decremental lookup table LUT11, and LUT12 represents a relationship between an input grayscale value and an output grayscale value when the compensation operation is performed based on the first incremental lookup table LUT12.

Referring to FIGS. 8, 9, and 10, when block S320 or block S333 is performed, the grayscale value GS_T of the first data DT may be maintained. For example, the grayscale value GS_T may be maintained to about 32 grayscale (32 grayscale units). When block S341 is performed, the grayscale value GS_T of the first data DT may decrease. For example, the grayscale value GS_T may decrease, based on the first decremental lookup table LUT11, from about 32 grayscale (32 grayscale units) to about 26 grayscale (26 grayscale units). When block S343 is performed, the grayscale value GS_T of the first data DT may increase. For example, the grayscale value GS_T may increase, based on the first incremental lookup table LUT12, from about 32 grayscale (32 grayscale units) to about 38 grayscale (38 grayscale units).

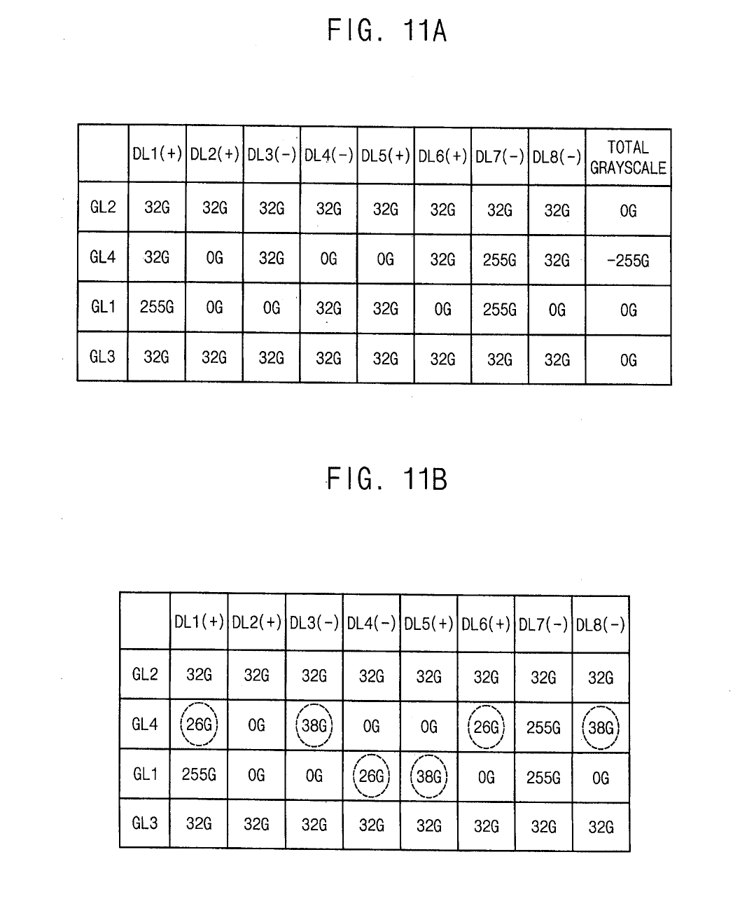

FIG. 11A is a table illustrating an example of grayscale values of subpixels in the display panel 100 when the compensation operation is not performed. FIG. 11B is a table illustrating an example of grayscale values of subpixels in the display panel 100 when the compensation operation is performed based on the lookup tables LUT11 and LUT12. In the example of FIGS. 11A and 11B, the display panel 100 may have the configuration illustrated in FIG. 3.

Referring to FIGS. 11A and 11B, the sequence of enabling the gate lines may be GL2→GL4→GL1→GL3. The plurality of first subpixel data may be data for driving the subpixels R1, B1, G2, W2, W3, G3, B4, and R4 that are connected to the second gate line GL2. The plurality of second subpixel data may be data for driving the subpixels R5, B5, G6, W6, W7, G7, B8, and R8 that are connected to the fourth gate line GL4.

As illustrated in FIG. 11A, the first total grayscale value associated with the plurality of first subpixel data may be about 0G (0 grayscale), and the second total grayscale value associated with the plurality of second subpixel data may be about −255G (−255 grayscale). When the second total grayscale value decreases from the first total grayscale value, a level of the common voltage may decrease. In this case, if the first difference GS_DIFF between the first total grayscale value and the second total grayscale value is equal to or greater than the first reference value REF1, a subpixel driven based on positive subpixel data may have luminance that is higher than a target luminance, and a subpixel driven based on negative subpixel data may have luminance that is lower than a target luminance.

Accordingly, as illustrated in FIG. 11B, the plurality of second subpixel data may be compensated based on the lookup tables LUT11 and LUT12. For example, grayscale values of the plurality of second positive subpixel data may decrease (e.g., 32G (32 grayscale)→26G (26 grayscale)) based on the first decremental lookup table LUT11. Grayscale values of the plurality of second negative subpixel data may increase (e.g., 32G→38G) based on the first incremental lookup table LUT12.

Similarly, a plurality of third subpixel data may be data for driving the subpixels G1, W1, R2, and B2 that are connected to the first gate line GL1. A third total grayscale value associated with the plurality of third subpixel data may be about 0G (0 grayscale). When the third total grayscale value increases from the second total grayscale value, the level of the common voltage may decrease. In this case, if a second difference between the second total grayscale value and the third total grayscale value is equal to or greater than the first reference value REF1, a subpixel driven based on positive subpixel data may have luminance that is lower than a target luminance, and a subpixel driven based on negative subpixel data may have luminance that is higher than a target luminance. Accordingly, the plurality of third subpixel data may be compensated based on the lookup tables LUT11 and LUT12. For example, grayscale values of a plurality of third positive subpixel data among the plurality of third subpixel data may increase (e.g., 32G→38G) based on the first incremental lookup table LUT12. Grayscale values of a plurality of third negative subpixel data among the plurality of third subpixel data may decrease (e.g., 32G→26G) based on the first decremental lookup table LUT11.

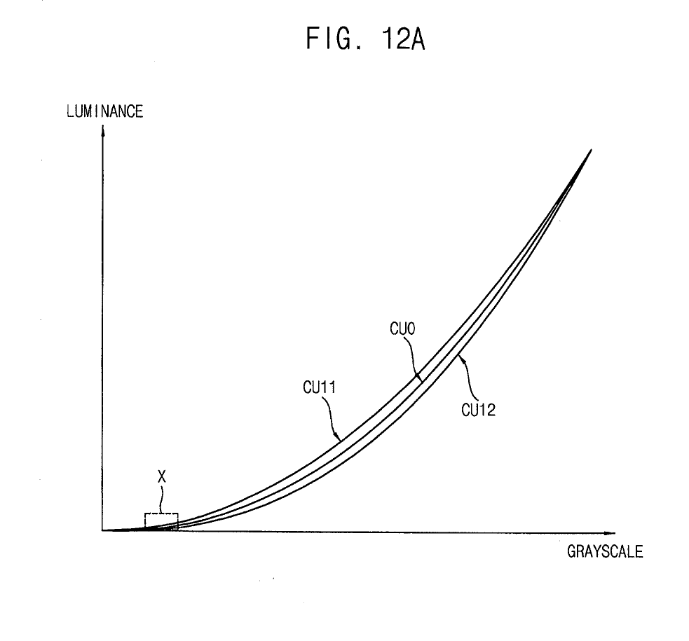

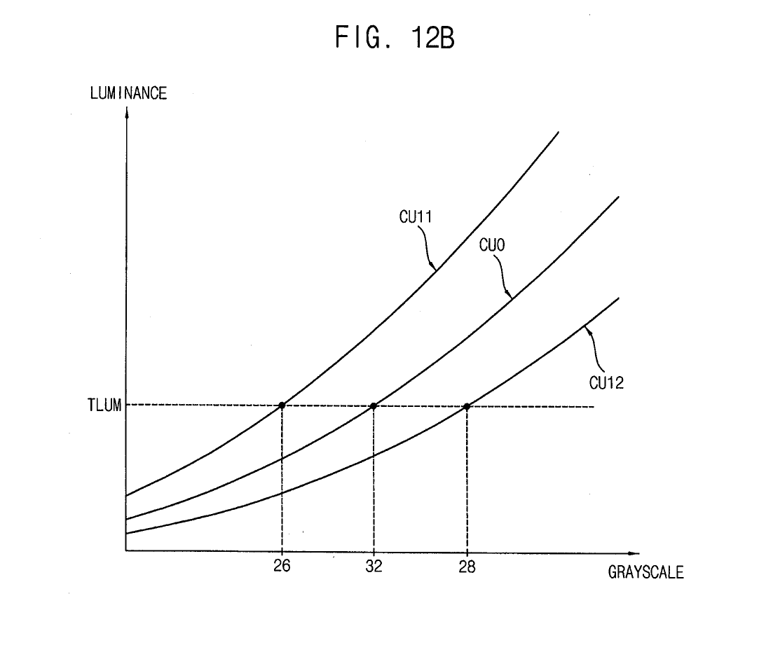

FIG. 12A is a graph illustrating a variation of luminance by the compensation operation in FIGS. 8 and 9. In FIG. 12A, CUO represents a relationship between a grayscale value and luminance when the compensation operation is not performed, CU11 represents a relationship between a grayscale value and luminance when the compensation operation is performed based on the first decremental lookup table LUT11, and CU12 represents a relationship between a grayscale value and a luminance when the compensation operation is performed based on the first incremental lookup table LUT12. FIG. 12B is an enlarged view of a portion “X” in FIG. 12A.

Referring to FIGS. 12A and 12B, when the compensation operation is not performed (e.g., in the curve CUO), a target luminance TLUM may appear based on a grayscale value of about 32G. When the compensation operation is performed based on the first decremental lookup table LUT11 (e.g., in the curve CU11), the target luminance TLUM may appear based on a grayscale value of about 26G. When the compensation operation is performed based on the first incremental lookup table LUT12 (e.g., in the curve CU12), the target luminance TLUM may appear based on a grayscale value of about 38G.

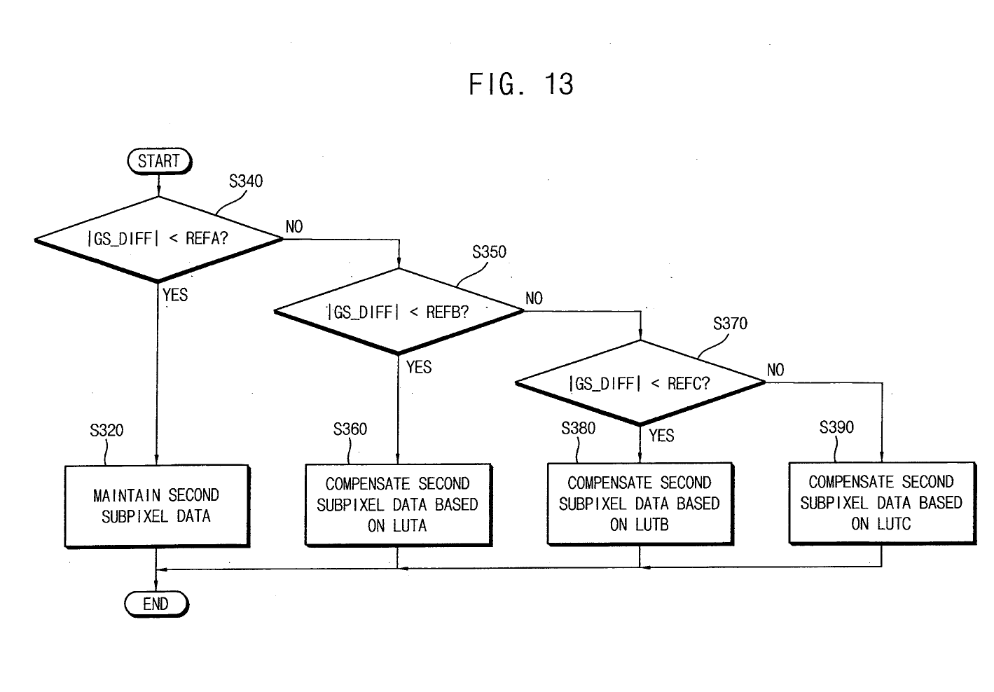

FIG. 13 is a flow chart illustrating another example of selectively compensating the plurality of second subpixel data in FIG. 5.

Referring to FIGS. 5 and 8, in block S300, a first difference GS_DIFF between the first total grayscale value and the second total grayscale value may be compared with a first reference value REFA (block S340). The first difference GS_DIFF may be compared with a second reference value REFB (block S350). The first difference GS_DIFF may be compared with a third reference value REFC (block S370).

When the first difference GS_DIFF is less than the first reference value REFA (block S340: YES), the plurality of second subpixel data may be maintained (block S320). When the first difference GS_DIFF is equal to or greater than the first reference value REFA (block S340: NO), and when the first difference GS_DIFF is less than the second reference value REFB (block S350: YES), the plurality of second subpixel data may be compensated based on a first lookup table LUTA (block S360). When the first difference GS_DIFF is equal to or greater than the second reference value REFB (block S350: NO), and when the first difference GS_DIFF is less than the third reference value REFC (block S370: YES), the plurality of second subpixel data may be compensated based on a second lookup table LUTB (block S380). When the first difference GS_DIFF is equal to or greater than the third reference value REFC (block S370: NO), the plurality of second subpixel data may be compensated based on a third lookup table LUTC (block S390).

In some example embodiments, the second reference value REFB may be greater than the first reference value REFA and may be less than the third reference value REFC. For example, the first reference value REFA, the second reference value REFB and the third reference value REFC may be represented by Equation 3, Equation 4 and Equation 5, respectively.

REFA=DSMAX/4 Equation 3

REFB=DSMAX/2 Equation 4

REFC=DSMAX*3/4 Equation 5

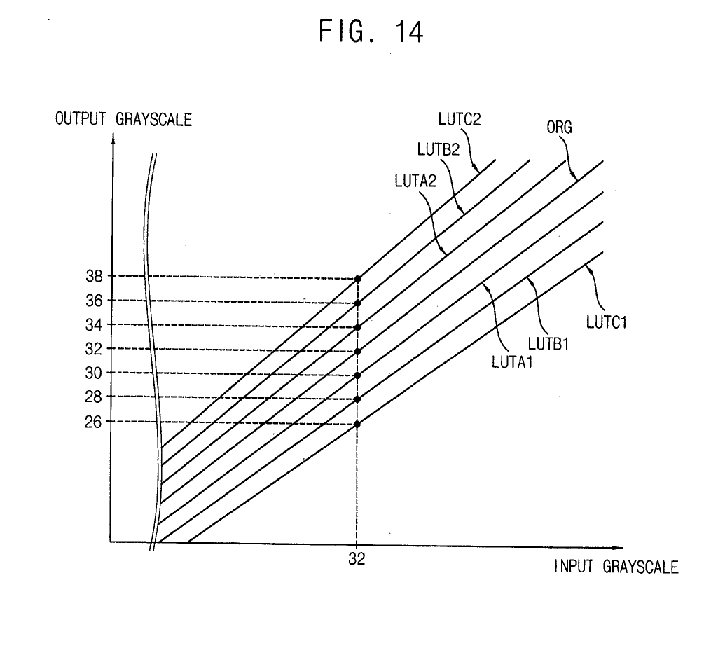

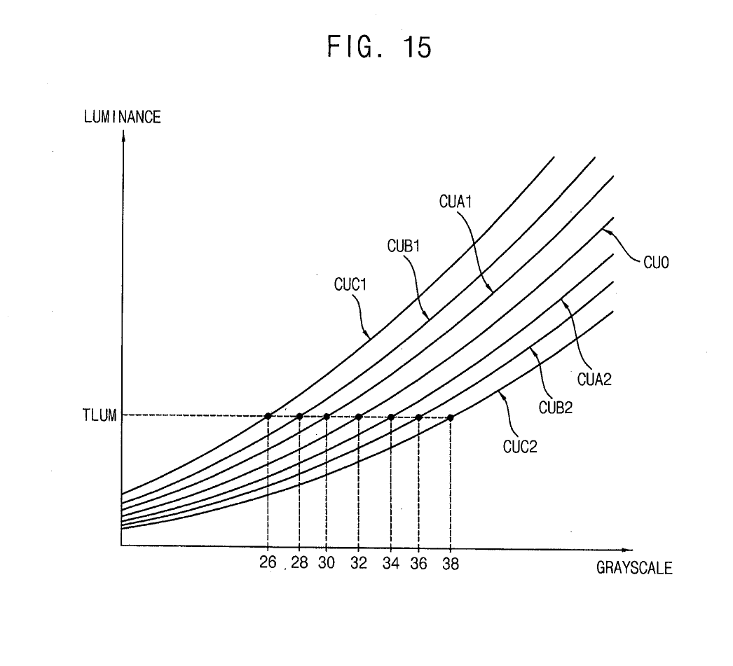

In this case, as will be described below with reference to FIGS. 14 and 15, a first amount of compensation for the second subpixel data based on the first lookup table LUTA may be less than a second amount of compensation for the second subpixel data based on the second lookup table LUTB. The second amount of compensation for the second subpixel data based on the second lookup table LUTB may be less than a third amount of compensation for the second subpixel data based on the third lookup table LUTC.

Each of blocks S360, S380, and S390 may be performed similarly to the example illustrated in FIG. 9.

FIGS. 14 and 15 are diagrams for describing a compensation operation in FIG. 13.

FIG. 14 is a graph illustrating an example of the lookup tables LUTA, LUTB, and LUTC that are used for performing the compensation operation in FIG. 13. In FIG. 14, ORG represents a relationship between an input grayscale value and an output grayscale value when the compensation operation is not performed, LUTA1 represents a relationship between an input grayscale value and an output grayscale value when the compensation operation is performed based on a first decremental lookup table of the first lookup table LUTA, LUTA2 represents a relationship between an input grayscale value and an output grayscale value when the compensation operation is performed based on a first incremental lookup table of the first lookup table LUTA, LUTB1 represents a relationship between an input grayscale value and an output grayscale value when the compensation operation is performed based on a second decremental lookup table of the second lookup table LUTB, LUTB2 represents a relationship between an input grayscale value and an output grayscale value when the compensation operation is performed based on a second incremental lookup table of the second lookup table LUTB, LUTC1 represents a relationship between an input grayscale and an output grayscale value when the compensation operation is performed based on a third decremental lookup table of the third lookup table LUTC, and LUTC2 represents a relationship between an input grayscale value and an output grayscale value when the compensation operation is performed based on a third incremental lookup table of the third lookup table LUTC.

Referring to FIGS. 13 and 14, when block S320 is performed, the grayscale value GS_T of the first data DT may be maintained. For example, the grayscale value GS_T may be maintained to about 32 grayscale (32 grayscale units or 32G).

When block S360 is performed, the grayscale value GS_T of the first data DT may decrease or may increase. For example, the grayscale value GS_T may decrease, based on the first decremental lookup table LUTA1, from about 32 grayscale (32 grayscale units) to about 30 grayscale (30 grayscale units or 30G). The grayscale value GS_T may increase, based on the first incremental lookup table LUTA2, from about 32 grayscale to about 34 grayscale.

When block S380 is performed, the grayscale value GS_T of the first data DT may decrease or may increase. For example, the grayscale value GS_T may decrease, based on the second decremental lookup table LUTB1, from about 32 grayscale (32 grayscale units) to about 28 grayscale (28 grayscale units or 28G). The grayscale value GS_T may increase, based on the second incremental lookup table LUTB2, from about 32 grayscale (32 grayscale units or 32G) to about 36 grayscale (36 grayscale units or 36G).

When block S390 is performed, the grayscale value GS_T of the first data DT may decrease or may increase. For example, the grayscale value GS_T may decrease, based on the third decremental lookup table LUTC1, from about 32 grayscale (32 grayscale units) to about 26 grayscale (26 grayscale units). The grayscale value GS_T may increase, based on the third incremental lookup table LUTC2, from about 32 grayscale (32 grayscale units) to about 38 grayscale (38 grayscale units).

FIG. 15 is a graph illustrating a variation of luminance by the compensation operation in FIG. 13. In FIG. 15, CUO represents a relationship between a grayscale and luminance when the compensation operation is not performed, CUA1 represents a relationship between a grayscale value and luminance when the compensation operation is performed based on the first decremental lookup table LUTA1, CUA2 represents a relationship between a grayscale value and a luminance when the compensation operation is performed based on the first incremental lookup table LUTA2, CUB1 represents a relationship between a grayscale value and luminance when the compensation operation is performed based on the second decremental lookup table LUTB1, CUB2 represents a relationship between a grayscale value and a luminance when the compensation operation is performed based on the second incremental lookup table LUTB2, CUC1 represents a relationship between a grayscale value and luminance when the compensation operation is performed based on the third decremental lookup table LUTC1, and CUC2 represents a relationship between a grayscale value and a luminance when the compensation operation is performed based on the third incremental lookup table LUTC2.

Referring to FIG. 15, when the compensation operation is not performed (e.g., in the curve CUO), a target luminance TLUM may appear based on a grayscale value of about 32G. When the compensation operation is performed based on the first, second, and third decremental lookup tables LUTA1, LUTB1 and LUTC1 (e.g., in the curves CUA1, CUB1, and CUC1), the target luminance TLUM may appear based on a grayscale value of about 30G (30 grayscale), 28G (28 grayscale), and 26G (26 grayscale), respectively. When the compensation operation is performed based on the first, second, and third incremental lookup tables LUTA2, LUTB2, and LUTC2 (e.g., in the curves CUA2, CUB2, and CUC2), the target luminance TLUM may appear based on a grayscale value of about 34G (34 grayscale), 36G (36 grayscale), and 38G (38 grayscale), respectively.

Although the example embodiments are described based on the example where the compensation operation is performed for a specific grayscale value (e.g., about 32G), the example embodiments will be employed to an example where the compensation operation is performed for various suitable grayscale values. In addition, although the example embodiments are described based on the example where the compensation operation is performed based on one lookup table or three lookup tables, the example embodiments will be employed to an example where the compensation operation is performed based on any number of lookup tables.

The above described embodiments may be used in a display apparatus and/or a system including the display apparatus, such as a mobile phone, a smart phone, a personal digital assistants (PDA), a portable multimedia player (PMP), a digital camera, a digital television, a set-top box, a music player, a portable game console, a navigation device, a personal computer (PC), a server computer, a workstation, a tablet computer, a laptop computer, a smart card, a printer, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims, and equivalents thereof.

What is claimed is:

1. A method of operating a display panel, the method comprising:
obtaining a first total grayscale value associated with a plurality of first subpixel data, the plurality of first subpixel data corresponding to a plurality of first data voltages applied to a plurality of data lines during a first horizontal period;
obtaining a second total grayscale value associated with a plurality of second subpixel data, the plurality of second subpixel data corresponding to a plurality of second data voltages applied to the plurality of data lines during a second horizontal period subsequent to the first horizontal period; and
selectively compensating the plurality of second subpixel data based on the first total grayscale value and the second total grayscale value.

2. The method of claim 1, wherein the obtaining of the first total grayscale value comprises:
generating a first sum grayscale value by adding first grayscale values of a plurality of positive subpixel data from among the plurality of first subpixel data, each of the plurality of positive subpixel data corresponding to a positive data voltage having a positive polarity with respect to a common voltage;
generating a second sum grayscale value by adding second grayscale values of a plurality of negative subpixel data from among the plurality of first subpixel data, each of the plurality of negative subpixel data corresponding to a negative data voltage having a negative polarity with respect to the common voltage; and
generating the first total grayscale value by subtracting the second sum grayscale value from the first sum grayscale value.

3. The method of claim 1, wherein the obtaining of the second total grayscale value comprises:
generating a first sum grayscale value by adding first grayscale values of a plurality of positive subpixel data from among the plurality of second subpixel data, each of the plurality of positive subpixel data corresponding to a positive data voltage having a positive polarity with respect to a common voltage;
generating a second sum grayscale value by adding second grayscale values of a plurality of negative subpixel data from among the plurality of second subpixel data, each of the plurality of negative subpixel data corresponding to a negative data voltage having a negative polarity with respect to the common voltage; and
generating the second total grayscale value by subtracting the second sum grayscale value from the first sum grayscale value.

4. The method of claim 1, wherein the selectively compensating of the plurality of second subpixel data comprises:
compensating the plurality of second subpixel data based on a first lookup table when a first difference between the first total grayscale value and the second total grayscale value is equal to or greater than a first reference value; and
maintaining the plurality of second subpixel data when the first difference is less than the first reference value.

5. The method of claim 4, wherein the compensating of the plurality of second subpixel data based on the first lookup table comprises:
decreasing a first grayscale value of first positive subpixel data from among the plurality of second subpixel data based on the first lookup table when the first total grayscale value is greater than the second total grayscale value, the first positive subpixel data corresponding to a positive data voltage having a positive polarity with respect to a common voltage; and
increasing the first grayscale value based on the first lookup table when the first total grayscale value is less than the second total grayscale value.

6. The method of claim 5, wherein the compensating of the plurality of second subpixel data based on the first lookup table further comprises:
increasing a second grayscale value of first negative subpixel data from among the plurality of second subpixel data based on the first lookup table when the first total grayscale value is greater than the second total grayscale value, the first negative subpixel data corresponding to a negative data voltage having a negative polarity with respect to the common voltage; and
decreasing the second grayscale value based on the first lookup table when the first total grayscale value is less than the second total grayscale value.

7. The method of claim 5, wherein the compensating of the plurality of second subpixel data based on the first lookup table further comprises:
maintaining the first grayscale value when the first grayscale value corresponds to one of a maximum grayscale value and a minimum grayscale value.

8. The method of claim 1, wherein the selectively compensating of the plurality of second subpixel data comprises:
compensating the plurality of second subpixel data based on a first lookup table when a first difference between the first total grayscale value and the second total grayscale value is equal to or greater than a first reference value and is less than a second reference value;
compensating the plurality of second subpixel data based on a second lookup table when the first difference is equal to or greater than the second reference value and is less than a third reference value;
compensating the plurality of second subpixel data based on a third lookup table when the first difference is equal to or greater than the third reference value; and
maintaining the plurality of second subpixel data when the first difference is less than the first reference value.

9. The method of claim 8, wherein the second reference value is greater than the first reference value and is less than the third reference value,
wherein a first amount of compensation for the second subpixel data based on the first lookup table is less than a second amount of compensation for the second subpixel data based on the second lookup table, and
wherein the second amount of compensation for the second subpixel data based on the second lookup table is less than a third amount of compensation for the second subpixel data based on the third lookup table.

10. The method of claim 1, wherein the display panel comprises:
a plurality of subpixels; and
a plurality of gate lines connected to the plurality of subpixels,
wherein a first gate line of the plurality of gate lines is connected to some of first subpixels from among the plurality of subpixels and some of second subpixels from among the plurality of subpixels, the first gate line is enabled during the second horizontal period, the first subpixels are located in a first subpixel row adjacent to the first gate line, and the second subpixels are located in a second subpixel row, the second pixel row being adjacent to the first gate line and different from the first subpixel row.

11. The method of claim 10, wherein a pixel of the display panel includes at least two subpixels located in a same subpixel row and adjacent to one other.

12. A display apparatus comprising:
a display panel comprising a plurality of subpixels, each of the plurality of subpixels being connected to a respective one of a plurality of gate lines and a respective one of a plurality of data lines;
a data driver configured to generate a plurality of first data voltages based on a plurality of first subpixel data to apply the plurality of first data voltages to the plurality of data lines during a first horizontal period, and to generate a plurality of second data voltages based on a plurality of second subpixel data to apply the plurality of second data voltages to the plurality of data lines during a second horizontal period subsequent to the first horizontal period; and
a timing controller configured to control an operation of the data driver, to obtain a first total grayscale value associated with the plurality of first subpixel data, to obtain a second total grayscale value associated with the plurality of second subpixel data, and to selectively compensate the plurality of second subpixel data based on the first total grayscale value and the second total grayscale value.

13. The display apparatus of claim 12, wherein the timing controller is
configured to generate a first sum grayscale value by adding first grayscale values of a plurality of positive subpixel data from among the plurality of first subpixel data,
to generate a second sum grayscale value by adding second grayscale values of a plurality of negative subpixel data from among the plurality of first subpixel data, and
to generate the first total grayscale value by subtracting the second sum grayscale value from the first sum grayscale value,
wherein each of the plurality of positive subpixel data corresponds to a positive data voltage having a positive polarity with respect to a common voltage, and
wherein each of the plurality of negative subpixel data corresponds to a negative data voltage having a negative polarity with respect to the common voltage.

14. The display apparatus of claim 12, wherein the timing controller is
configured to generate a first sum grayscale value by adding first grayscale values of a plurality of positive subpixel data from among the plurality of second subpixel data,
to generate a second sum grayscale value by adding second grayscale values of a plurality of negative subpixel data from among the plurality of second subpixel data, and
to generate the second total grayscale value by subtracting the second sum grayscale value from the first sum grayscale value,
wherein each of the plurality of positive subpixel data corresponds to a positive data voltage having a positive polarity with respect to a common voltage, and
wherein each of the plurality of negative subpixel data corresponds to a negative data voltage having a negative polarity with respect to the common voltage.

15. The display apparatus of claim 12, wherein the timing controller is
configured to compensate the plurality of second subpixel data based on a first lookup table when a first difference between the first total grayscale value and the second total grayscale value is equal to or greater than a first reference value, and
configured to maintain the plurality of second subpixel data when the first difference is less than the first reference value.

16. The display apparatus of claim 15, wherein the timing controller is
configured to decrease a first grayscale value of first positive subpixel data from among the plurality of second subpixel data based on the first lookup table when the first total grayscale value is greater than the second total grayscale value, and
to increase the first grayscale value based on the first lookup table when the first total grayscale value is less than the second total grayscale value, and
wherein the first positive subpixel data corresponds to a positive data voltage having a positive polarity with respect to a common voltage.

17. The display apparatus of claim 16, wherein the timing controller is
configured to increase a second grayscale value of first negative subpixel data from among the plurality of second subpixel data based on the first lookup table when the first total grayscale value is greater than the second total grayscale value, and
to decrease the second grayscale value based on the first lookup table when the first total grayscale value is less than the second total grayscale value, and
wherein the first negative subpixel data corresponds to a negative data voltage having a negative polarity with respect to the common voltage.

18. The display apparatus of claim 16, wherein the timing controller is configured to maintain the first grayscale value when the first grayscale value corresponds to one of a maximum grayscale value and a minimum grayscale value.

19. The display apparatus of claim 12, wherein the timing controller is
configured to compensate the plurality of second subpixel data based on a first lookup table when a first difference between the first total grayscale value and the second total grayscale value is equal to or greater than a first reference value and is less than a second reference value,
to compensate the plurality of second subpixel data based on a second lookup table when the first difference is equal to or greater than the second reference value and is less than a third reference value,
to compensate the plurality of second subpixel data based on a third lookup table when the first difference is equal to or greater than the third reference value, and
to maintain the plurality of second subpixel data when the first difference is less than the first reference value.

20. The display apparatus of claim 19, wherein the second reference value is greater than the first reference value and is less than the third reference value,
wherein a first amount of compensation for the second subpixel data based on the first lookup table is less than a second amount of compensation for the second subpixel data based on the second lookup table, and
wherein the second amount of compensation for the second subpixel data based on the second lookup table is less than a third amount of compensation for the second subpixel data based on the third lookup table.
